(19) United States
(12) Patent Application Publication
(10) Pub. No.: US 2026/0264210 A1
(43) Pub. Date: Sep. 10, 2026

(54) DETENT SYSTEM FOR HIGH TORQUE PRECISION FASTENING TOOLS

(71) Applicant: Ingersoll-Rand Industrial U.S., Inc., Davidson, NC (US)

(72) Inventors: Sudharshan Sureshkannan, Bangalore (IN); Amith Anoop Kumar, Bangalore (IN); Mark T. McClung, Byram Township, NJ (US); Satheeshkumar Ramasamy, Bangalore (IN)

(21) Appl. No.: 19/070,989

(22) Filed: Mar. 5, 2025

(51) Int. Cl. B25F 5/00; B25B 21/00; B25B 23/00

(52) U.S. Cl. CPC B25F 5/001; B25B 21/002; B25B 23/0078

(57) ABSTRACT

Detent systems for portable power tools are disclosed to facilitate connection between an output end of the power tool with a torque multiplier while permitting reorientation of a reaction arm of the torque multiplier relative to a handle on the power tool.

### BACKGROUND

Portable (hand-held) power tools include a variety of tools, which are actuated by a power source such as an electric or pneumatic motor, that are configured to be held by an operator during use. The power source drives internal drive components to generate torque at an output end of the power tool. The torque of portable power tools can be altered by coupling the output end with supplemental gearing.

### DRAWINGS

The Detailed Description is described with reference to the accompanying figures. In the figures, the use of the same reference numbers in different instances in the description and the figures may indicate similar or identical items.

FIG. 1A is an isometric view of a portable power tool having a torque multiplier system coupled with an output end of the portable power tool with a detent system in accordance with example embodiments of the present disclosure.

FIG. 1B is a side view of the portable power tool having the torque multiplier system of FIG. 1A in accordance with example embodiments of the present disclosure.

FIG. 1C is a partially exploded side view of the portable power tool and the torque multiplier system of FIG. 1A in accordance with example embodiments of the present disclosure.

FIG. 2 is a partial cross-sectional side view of the portable power tool having the torque multiplier system of FIG. 1A in accordance with example embodiments of the present disclosure.

FIG. 3 is a cross-sectional isometric view of a detent housing having a detent plate with a plurality of detent apertures of the portable power tool and the torque multiplier system of FIG. 1A in accordance with example embodiments of the present disclosure.

FIG. 4 is a partial cross-sectional side view of a portable power tool having a torque multiplier system in accordance with example embodiments of the present disclosure.

FIG. 5 is a cross-sectional isometric view of a detent housing having a detent plate with a plurality of detent apertures of the portable power tool and the torque multiplier system of FIG. 1A in accordance with example embodiments of the present disclosure.

### DETAILED DESCRIPTION

Although the subject matter has been described in language specific to structural features and/or process operations, it is to be understood that the subject matter defined in the appended claims is not necessarily limited to the specific features or acts described herein. Rather, the specific features and acts described herein are disclosed as example forms of implementing the claims.

### Overview

Power tools, such as powered torque fastening tools, are designed to deliver a high torque output with minimal exertion by the user. A motor drives gearing within the tool housing to spin an output end of the power tool, which applies the torque to a fastener in contact with the output end.

For high torque applications (e.g., up to 1500 ft-lb or higher torque), a torque multiplier can be connected with the output end of the power tool to increase the torque that would otherwise be delivered by the power tool. For example, the torque multiplier can include supplemental gearing (e.g., ring gear, planetary gear, rotary gear, etc.) that is driven by the power unit of the power tool via connection with the output end of the power tool to drive an output end of the power multiplier, which in turn acts on the fastener.

The torque multiplier includes a reaction arm used to physically ground the tool against an object in the vicinity of the fastener to avoid transferring the reaction force to the user holding the handle of the power tool. However, the torque multiplier adds to the overall tool length when applied to the power tool, potentially limiting access of the output end of the torque multiplier to the desired fastener. For instance, as the overall length of the power tool with an attached torque multiplier increases, the flexibility of accessing fasteners in differing work environments decreases due to physical inaccessibility of the output end of the torque multiplier to the fastener. As the overall length of the power tool with an attached torque multiplier increases, the weight of the system can also increase, which can cause user fatigue in operating the system due to the added weight.

The positioning of the reaction arm relative to the handle of the power tool can also impact the user experience when manipulating the power tool with the torque multiplier. For example, coupling arrangements between the power tool and the torque multiplier can cause the reaction arm to be free-spinning about the output end of the torque multiplier when not supported by the user or a physical grounding site. Such free-spinning of the reaction arm can make desired positioning of the reaction arm by a user cumbersome if the reaction arm continues to spin downwards due to the effects of gravity if not supported by the user, which in some work environments is challenging if not practically or spatially prohibited to keep the reaction arm supported until in contact with the physical grounding site.

Accordingly, the present disclosure is directed, at least in part, to a detent system for a portable power tool to facilitate connection between an output end of the power tool with a torque multiplier while permitting reorientation of the reaction arm relative to a handle on the power tool. The detent system includes a ball resisted against an aperture in a detent plate via a spring to hold the reaction arm in a user-specified position such that the detent plate acts against gravitational forces on the reaction arm to prevent the reaction arm from moving away from the user-specified position. The user can overcome the detent force between the spring-loaded ball and the aperture in the detent plate to reposition the reaction arm according to multiple positions to be able to abut the reaction arm against a physical grounding site near the fastener or place the reaction arm in close proximity thereto. The detent system couples between the power tool and the torque multiplier gearbox to position the ball and spring radially about the output end of the power tool as opposed to in front of the output end, which provides a reduction in overall length and weight of the power tool with the attached torque multiplier as compared to systems that position the ball and spring in an axially-forward position relative to the output end of the power tool. Such radially-oriented detent system configurations also provide an offset to reactional torque that would otherwise reach the user’s hand during operation of systems that introduce detent structures axially forward of the output end of the power tool.

### Example Implementations

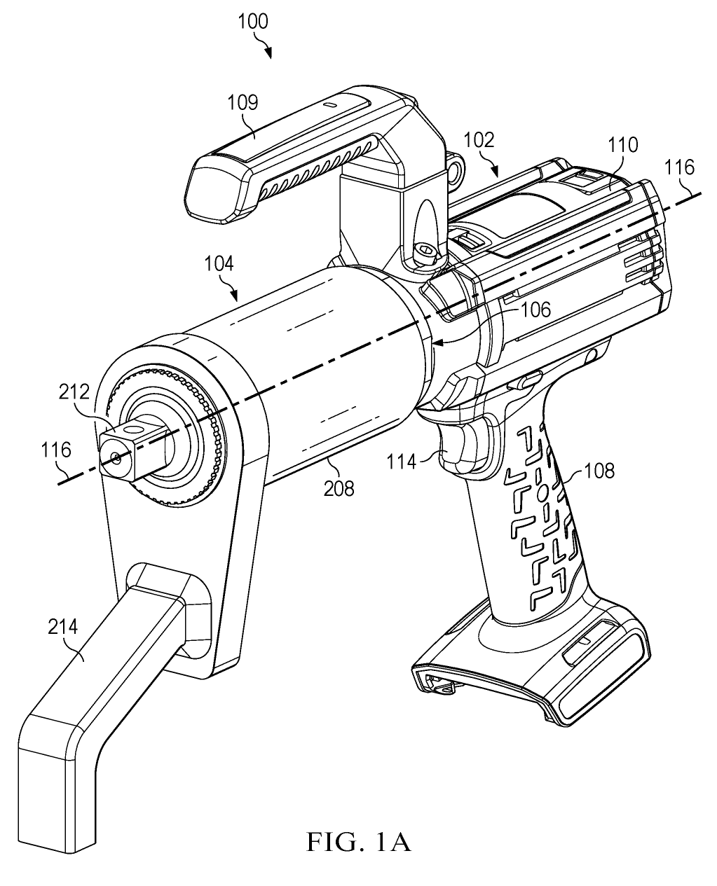

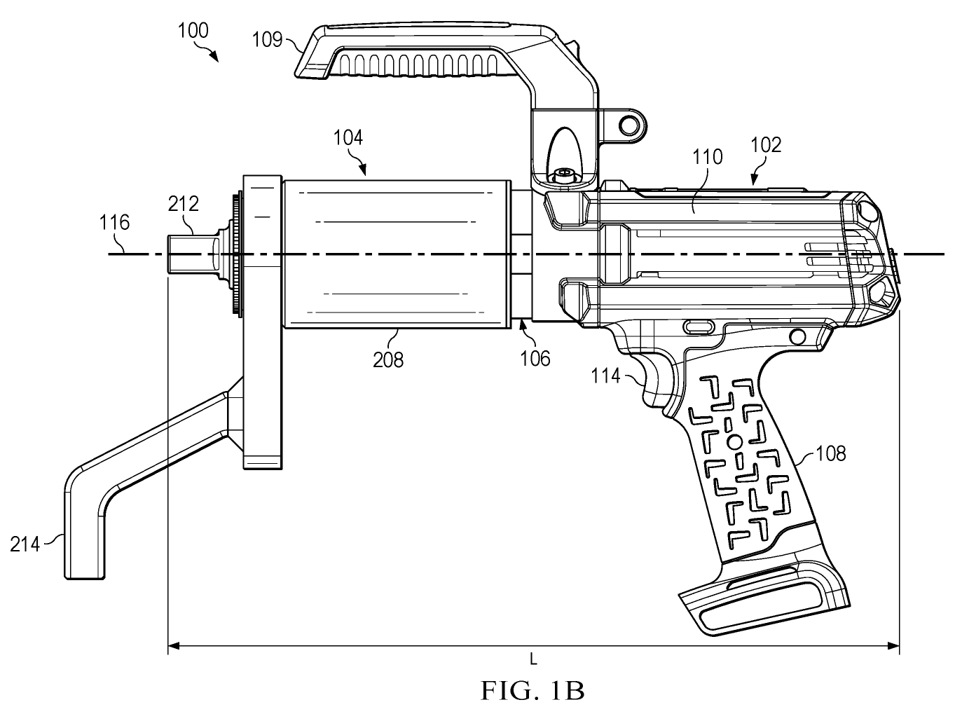

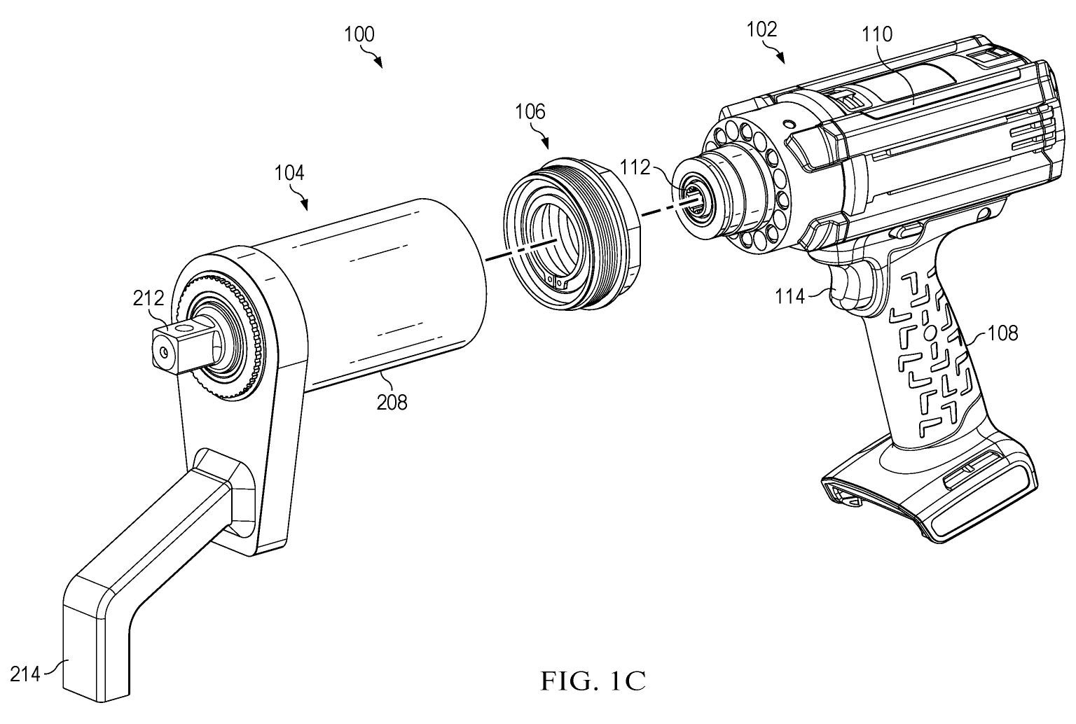

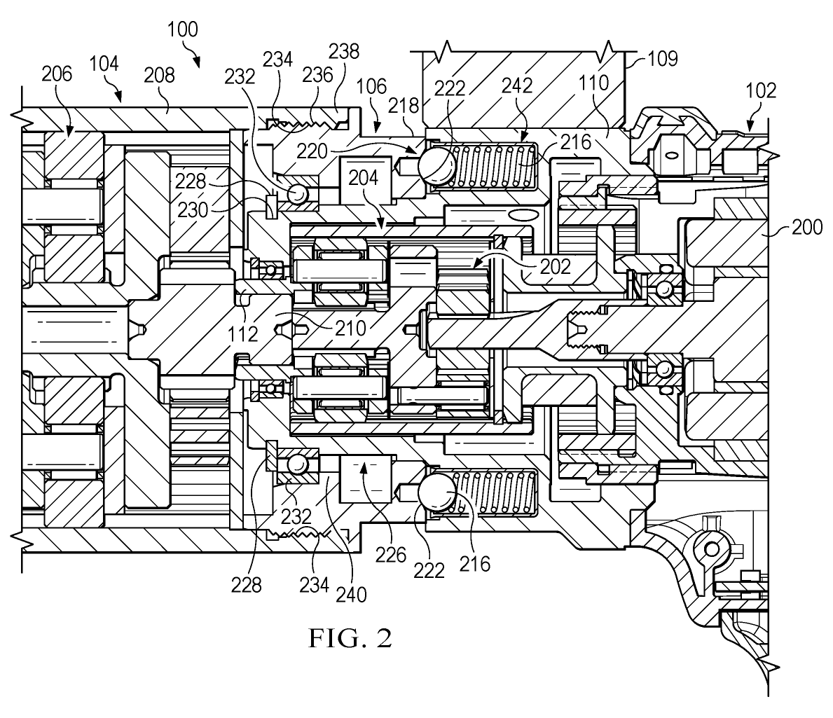

Referring generally to FIGS. 1A-5, power tool systems (“system 100”) are shown having detent systems to couple a portable power tool with a torque multiplier system to facilitate clutch coupling between the portable power tool and the torque multiplier system. An example embodiment of the system 100 is shown in FIGS. 1A-2 generally including a power tool 102, a torque multiplier system 104, and a detent system 106 coupled between the power tool 102 and the torque multiplier system 104. The power tool 102 is shown as a portable power tool configured for hand-held operation and includes a handle 108 coupled to or formed with a tool housing 110 for supporting a drive mechanism (e.g., drive mechanism 200 shown in FIG. 2) to rotate a tool output 112. Alternative or additionally, the power tool 102 can include an auxiliary handle 109 positioned on the tool housing 110 to assist a user in manipulating the system 100.

The power tool 102 can include a trigger 114 connected with the drive mechanism 200 to rotate the tool output 112 upon activation of the trigger 114. The drive mechanism 200 is shown as an electric motor powered by a power source (not shown), such as a removeable battery, an internal battery, or an external power source via an electric cord. For example, a removable battery can be attached to the handle 108 of the power tool 102 to provide internal electrical connection with the drive mechanism 200. However, it is contemplated that the power tool 102 may also comprise a pneumatic tool having a drive mechanism 200 employing a pneumatic motor powered by a pneumatic fluid (e.g., compressed air).

The power tool 102 further includes a gear assembly (e.g., power tool gear assembly 202 shown in FIG. 2) coupled with the drive mechanism 200. The gear assembly 202 comprises a gear train that transmits torque (driving power) from the drive mechanism 200 to the tool output 112 to rotate the tool output 112 about a drive axis 116. The gear assembly 202 can be supported within a gearbox 204 formed by or positioned within the tool housing 110 to enclose the gear assembly 202 within the tool housing 110.

The torque multiplier system 104 couples with the tool output 112 through the detent system 106 to connect the tool output 112 with supplemental gearing (e.g., multiplier gear assembly 206 shown in FIG. 2) supported within a multiplier gearbox 208. For example, the tool output 112 of the power tool 102 can be coupled with a drive shaft 210 of the torque multiplier system 104 that drives rotation of the multiplier gear assembly 206 about the drive axis 116, which in turn drives a multiplier tool output 212. The multiplier gear assembly 206 can include, but is not limited to, any number or combination of ring gears, planetary gears, rotary gears, or the like, to provide a desired torque output at the multiplier tool output 212.

The multiplier tool output 212 can include or can be coupled with a connector or other device that engages a fastener (e.g., a bolt, a nut, a screw, etc.) to be tightened or loosened. Upon activation of the drive mechanism 200 (e.g., via activation of the trigger 114), the drive mechanism 200 rotates the tool output 112 about the drive axis 116, which in turn rotates the drive shaft 210 of the torque multiplier system 104, where the multiplier gear assembly 206 can increase torque applied to the multiplier tool output 212 to drive a fastener.

The torque multiplier system 104 includes a reaction arm 214 to react the torque generated by the multiplier gear assembly 206 on the multiplier tool output 212 by bracing against a mechanically grounded site (e.g., another fastener, a pipe flange, etc.) adjacent the fastener to be worked upon by the system 100. For instance, the reaction arm 214 can be physically connected with the multiplier gear assembly 206 (e.g., via a spline coupling) to react the torque output by the system 100. For example, the reaction arm 214 can be rotatable about the drive axis 116 to bring a portion of the reaction arm 214 adjacent to the grounding site such that, upon activation of the drive mechanism 200, the reaction arm 214 is rotated about the drive axis 116 until contact is made between the grounding site and the reaction 214 to permit the multiplier tool output 212 to further drive the fastener.

The detent system 106 is coupled between the power tool 102 and the torque multiplier system 104 to provide disengagement of the torque multiplier system 104 and the power tool 102 while allowing reorientation of the reaction arm 214 relative to handle 108 of the power tool 102 and while maintaining the position of the reaction arm 214 (e.g., by providing sufficient retention force to overcome the gravitational force active upon the reaction arm 214). The detent system 106 permits a user of the system to find a desired positioning of the handle 108 and the reaction arm 214, without the reaction arm 214 slipping out of the desired position, to approach a fastener and allow the reaction arm 214 to abut a grounding site to drive the fastener with the multiplier tool output 212 about the drive axis 116.

The detent system 106 generally includes a ball and spring device 216 and a detent plate 218 defining one or more detent apertures 220 into which the spring of the ball and spring device 216 biases the ball. The ball and spring device 216 is shown as an encapsulated nose plunger to maintain the ball and the spring within the housing of the nose plunger, however the system 100 is not limited to such configuration and can include a connected ball and spring, a loose ball and spring, or any other configuration such that the spring biases the ball towards the detent plate 218. Further, it is contemplated that other shapes of the ball of the ball and spring device 216 can be utilized, such as rectangular shapes, angled shapes, irregular shapes, or the like, or that other detent torque-resistive structures can be utilized, without departing from the scope of the present disclosure.

Contact between the ball of the ball and spring device 216 and sidewalls 222 of the detent aperture 220 formed by the detent plate 218 resists rotational movement of the torque multiplier system 104 relative to the power tool 102 until the rotational force overcomes the detent force between the spring-loaded ball and the sidewalls 222 of the aperture 220 in the detent plate 218, causing the ball to slip from the detent aperture 220, permitting rotational movement of the torque multiplier system 104 relative to the power tool 102. The sidewalls 222 can be any shape configured to contact with the ball of the ball and spring device 216, and in implementations, the sidewalls 222 are tapered, sloped, or otherwise inwardly oriented with respect to the detent plate 218 to receive the ball into the detent aperture 220 and provide a resistive force against the rotational force of the torque multiplier system 104 relative to the power tool 102. In implementations, the detent aperture 220 or a portion thereof can include or be coupled with a grease reservoir to hold a quantity of grease or other lubricant to facilitate smooth movement of the detent system 106 or to protect against structural wear of the detent system 106 during operation of the system 100.

In implementations, the detent plate 218 defines a plurality of detent apertures 220 (e.g., arranged in a ring shape) such that rotational movement of the torque multiplier system 104 relative to the power tool 102 aligns the ball of the ball and spring device 216 with one detent aperture 220, with continued rotational movement causing the ball to slip from the detent aperture 220 until the rotational movement brings the ball into contact with another detent aperture 220. The spring of the ball and spring device 216 can have a spring force suitable to offset the rotational force acting on the ball by the sidewalls 222 of the detent aperture 220 caused by gravitational forces acting on the reaction arm 214, such as when the reaction arm 214 is positioned by a user in a horizontal position.

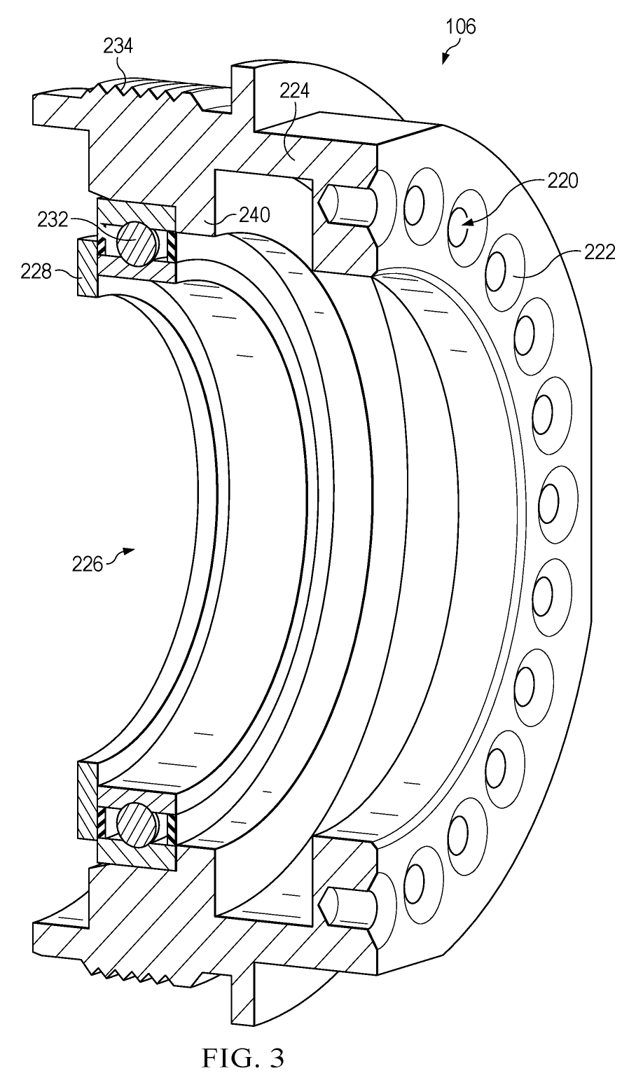

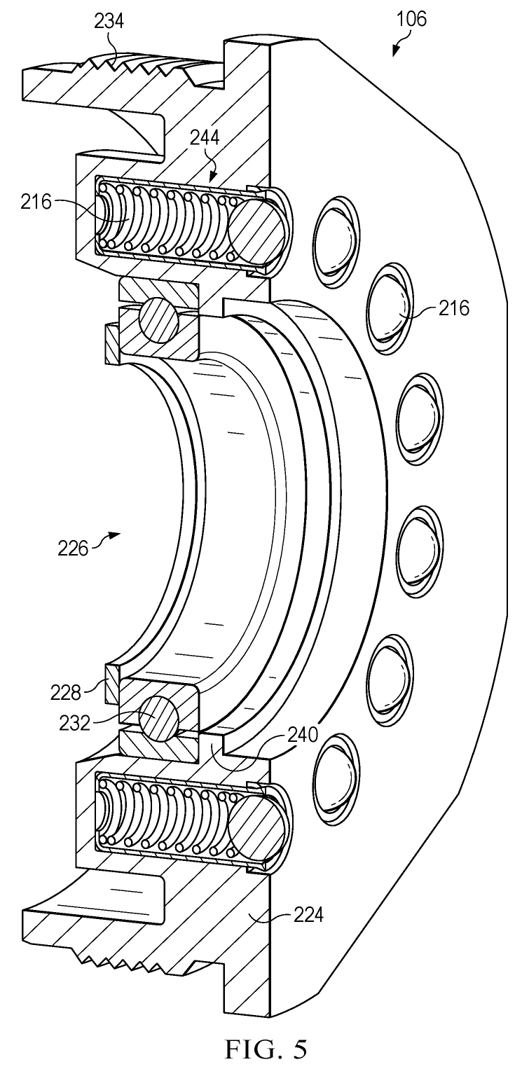

The detent system 106 can include a generally ring-shaped housing 224 (e.g., shown in FIGS. 3 and 5) to support one or more of the ball and spring device 216 and the detent plate 218 while permitting a portion of the tool housing 110 of the power tool 102 to pass through an aperture 226 defined by the housing 224 of the detent system 106 to couple the tool output 112 with the multiplier gear assembly 206 (e.g., via the drive shaft 210). For example, the tool housing 110 is shown in FIG. 2 having a front portion positioned within the aperture 226 to couple the tool output 112 with the drive shaft 210 of the torque multiplier system 104.

The detent system 106 can include features to couple with each of the power tool 102 and the torque multiplier system 104. For example, the detent housing 224 can support a retaining ring 228 within the aperture 226 to interface with a portion of the tool housing 110. For instance, the tool housing 110 is shown in FIG. 2 defining a groove 230 into which the retaining ring 228 rests to prevent axial motion of the power tool 102 relative to the torque multiplier system 104 with respect to the drive axis 116. When the retaining ring 228 is inserted into the groove 230, the detent system 106 positions the ball and spring device 216 radially outward from the output end of the power tool 102 with respect to the drive axis 116 (e.g., radially from one or more of the tool housing 110, the gearbox 220, or the tool output 112) as opposed to in front of the output end, which provides a reduction in overall length of the system 100 (shown as L in FIG. 1B) and a reduction in weight as compared to positioning the ball and spring in an axially-forward position relative to the output end of the power tool 102. Such reduction in length can permit the system 100 to have more accessibility with respect to fasteners in work environments than alternative configurations of the detent system 106 that introduce detent structures axially forward of the output end of the power tool 102. In implementations, the length reduction and weight reduction is up to about 17%. Additionally, by coupling the detent system 106 between the power tool 102 and the torque multiplier system 104 in the configurations described herein, the ball and spring device 216 generates a resistive torque against the rotational movement of detent plate 218 against the tool housing 110, which in turn offsets a portion of the reactional torque that would otherwise reach the user’s hand when gripping the handle 108 during operation of the system 100. In implementations, the system 100 included a detent torque from about 10 to 12 Nm which reduced the reactional torque reaching the user’s hand were reduced from about 6 to 7 Nm to about 2 to 3 Nm, representing a 50 to 60% reduction in reaction forces reaching the user’s hand when compared to systems that introduce detent structures axially forward of the output end of the power tool 102.

The detent housing 224 can support a bearing 232 within the aperture 226 to support the front of the tool housing 110 while permitting rotation of the torque multiplier system 104 relative to the tool housing 110, such as to reposition the reaction arm 214 relative to the handle 108 of the power tool 102, once the detent force between the ball and spring device 216 and the detent aperture 220 is overcome. The detent housing 224 is also shown including a threaded exterior surface 234 configured to couple with a complementarily-threaded interior surface 236 on an end 238 of the multiplier gearbox 208 opposite from the reaction arm 214 to couple the detent system 106 with the torque multiplier system 104. In implementations, the detent housing 224 includes a flange 240 extending towards the interior of the aperture 226 to provide a structure against which the bearing 232 rests. For example, the bearing 232 can be held within the detent housing 224 between the retaining ring 228 and the flange 240.

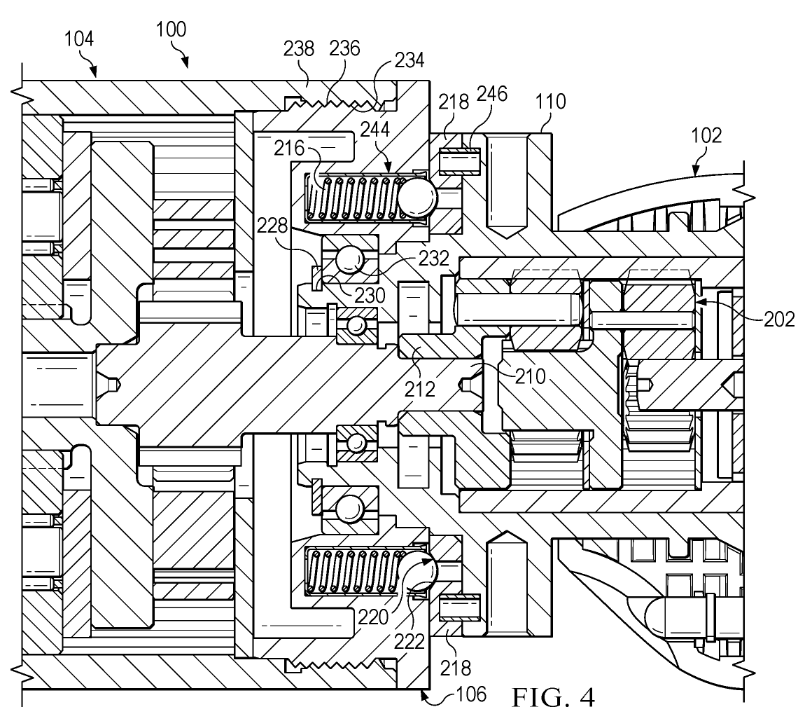

The housing 224 of the detent system 106 can facilitate any configuration of the ball and spring device 216 and the detent plate 218 such that the ball and spring device 216 biases the ball against the detent plate 218 in a manner to interact with the detent apertures 220. For example, the housing 224 of the detent system 106 is shown in FIGS. 2 and 3 supporting the detent plate 218 having a plurality of detent apertures 220, whereas the tool housing 110 supports a plurality of corresponding ball and spring devices 216 with apertures 242 formed in the tool housing 110 radially-arranged with respect to a front of the gearbox 204 (e.g., shown in FIG. 2). The housing 224 of the detent system 106 is shown in FIGS. 4 and 5 supporting a plurality of ball and spring devices 216 within apertures 244 formed in the housing 224, whereas the detent plate 218 with a corresponding plurality of detent apertures 220 is supported by the tool housing 110 (e.g., shown with pins 246 holding the detent plate 218 to the tool housing 110; alternatively or additionally, the detent plate 218 and the tool housing 100 can be secured together via a bolted joint or other fastening mechanism).

In implementations, to install the detent system 106 between the power tool 102 and the torque multiplier system 104, the detent system 106 is first installed onto the power tool 102, such as by inserting the ball and spring devices 216 within the apertures 242 formed in the tool housing 110, introducing the tool housing 110 through the aperture 226 of the housing 224 to align the detent plate 218 with the ball and spring devices 216, inserting the retaining ring 228 into the groove 230, and threading the end 238 of the multiplier gearbox 208 onto the threaded exterior surface 234 of the detent housing 224 to secure the drive shaft 210 of the torque multiplier system 104 relative to the tool output 112 of the power tool 102, such as for the system 100 shown in FIG. 2. Following installation of the detent system 106 between the power tool 102 and the torque multiplier system 104, the ball and spring devices 216 within the apertures 242 are positioned radially outward from the tool housing 110 with respect to the drive axis 116, thereby providing a shorter system 100 than if the ball and spring devices 216 were axially forward of the tool housing 110, permitting the system 100 to have more accessibility with respect to fasteners in work environments than alternative configurations of the detent system 106 that introduce detent structures axially forward of the tool housing 110.

In implementations, to install the detent system 106 between the power tool 102 and the torque multiplier system 104, the detent system 106 is first installed onto the power tool 102, such as by inserting the ball and spring devices 216 within the apertures 244 formed in the detent housing 224, introducing the tool housing 110 through the aperture 226 of the housing 224 to align the ball and spring devices 216 with the detent plate 218 (e.g., formed on or supported by the tool housing 110, such as with pins 246; alternatively or additionally, the detent plate 218 and the tool housing 100 can be secured together via a bolted joint or other fastening mechanism), inserting the retaining ring 228 into the groove 230, and threading the end 238 of the multiplier gearbox 208 onto the threaded exterior surface 234 of the detent housing 224 to secure the drive shaft 210 of the torque multiplier system 104 relative to the tool output 112 of the power tool 102, such as for the system 100 shown in FIG. 4. Following installation of the detent system 106 between the power tool 102 and the torque multiplier system 104, the ball and spring devices 216 within the apertures 244 are positioned radially outward from the tool housing 110 with respect to the drive axis 116, thereby providing a shorter system 100 than if the ball and spring devices 216 were axially forward of the tool housing 110, permitting the system 100 to have more accessibility with respect to fasteners in work environments than alternative configurations of the detent system 106 that introduce detent structures axially forward of the tool housing 110.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A portable power tool system comprising:
a power tool, the power tool including
a drive mechanism for powering a tool output about a drive axis,
a power tool gear assembly coupled with the drive mechanism, and
a housing for supporting and retaining the drive mechanism and the power tool gear assembly, the housing including a gearbox for enclosing the gear assembly;
a torque multiplier system, the torque multiplier system including
a multiplier gearbox for enclosing a multiplier gear assembly coupled with a multiplier tool output, and
a reaction arm coupled with the multiplier gear assembly and configured to abut a grounding site during driving of a fastener with the multiplier tool output about the drive axis; and
a detent system configured to couple with each of the power tool and the torque multiplier system, the detent system including
a detent housing for supporting at least one of a detent plate defining one or more detent apertures or a ball and spring device configured to push the ball against respective detent apertures of the one or more detent apertures, the detent housing defining an aperture through which a portion of the housing of the power tool can pass to couple the tool output with the multiplier gear assembly, wherein the ball and spring device is positioned radially outward from the power tool housing with respect to the drive axis when the detent system is coupled with the power tool.

2. The portable power tool system of claim 1, wherein the detent system further includes a retaining ring supported within the aperture defined by the detent housing, the retaining ring configured to couple with a front end of the power tool housing to prevent axial motion of the power tool relative to the torque multiplier system with respect to the drive axis.

3. The portable power tool system of claim 2, wherein the detent system further includes a bearing within the aperture defined by the detent housing to support the front end of the power tool housing within the detent housing.

4. The portable power tool system of claim 1, wherein the detent housing includes a threaded exterior surface, wherein the multiplier gearbox includes a complementarily-threaded interior surface on an end of the multiplier gearbox opposite from the reaction arm to couple the detent system with the torque multiplier system.

5. The portable power tool system of claim 4, wherein at least a portion of the end of the multiplier gearbox is positioned radially outward from the power tool gearbox with respect to the drive axis when secured to the detent housing.

6. The portable power tool system of claim 1, wherein the housing of the power tool defines a second aperture into which the ball and spring device is seated, and wherein the detent housing includes the detent plate positioned such that rotation of the reaction arm about the drive axis moves the one or more detent apertures into and out of alignment with the ball and spring device.

7. The portable power tool system of claim 6, wherein the second aperture is positioned radially outward from the power tool gearbox with respect to the drive axis when the detent system is coupled with the power tool.

8. The portable power tool system of claim 1, wherein the detent housing defines a second aperture into which the ball and spring device is seated, and wherein the detent plate is secured to the housing of the power tool such that rotation of the reaction arm about the drive axis moves the ball and spring device into and out of alignment with the one or more detent apertures.

9. The portable power tool system of claim 1, wherein the ball and spring device is positioned radially outward from the power tool gearbox with respect to the drive axis when the detent system is coupled with the power tool.

10. A portable power tool system comprising:
a power tool, the power tool including
a drive mechanism for powering a tool output about a drive axis,
a power tool gear assembly coupled with the drive mechanism, and
a housing for supporting and retaining the drive mechanism and the power tool gear assembly, the housing including a gearbox for enclosing the gear assembly, the housing further including an aperture configured to hold a ball and spring device;
a torque multiplier system, the torque multiplier system including
a multiplier gearbox for enclosing a multiplier gear assembly coupled with a multiplier tool output, and
a reaction arm coupled with the multiplier gear assembly and configured to abut a grounding site during driving of a fastener with the multiplier tool output about the drive axis; and
a detent system configured to couple with each of the power tool and the torque multiplier system, the detent system including
a detent housing defining one or more detent apertures positioned such that rotation of the reaction arm about the drive axis moves the one or more detent apertures into and out of alignment with the ball and spring device held within thein aperture of the power tool housing, the detent housing defining a second aperture through which a portion of the housing of the power tool can pass to couple the tool output with the multiplier gear assembly, wherein the ball and spring device is positioned radially outward from the power tool housing with respect to the drive axis when the detent system is coupled with the power tool.

11. The portable power tool system of claim 10, wherein the detent system further includes a retaining ring supported within the aperture defined by the detent housing, the retaining ring configured to couple with a front end of the power tool housing to prevent axial motion of the power tool relative to the torque multiplier system with respect to the drive axis.

12. The portable power tool system of claim 11, wherein the detent system further includes a bearing within the second aperture defined by the detent housing to support the front end of the power tool housing within the detent housing.

13. The portable power tool system of claim 10, wherein the detent housing includes a threaded exterior surface, wherein the multiplier gearbox includes a complementarily-threaded interior surface on an end of the multiplier gearbox opposite from the reaction arm to couple the detent system with the torque multiplier system.

14. The portable power tool system of claim 13, wherein at least a portion of the end of the multiplier gearbox is positioned radially outward from the power tool gearbox with respect to the drive axis when secured to the detent housing.

15. The portable power tool system of claim 10, wherein the ball and spring device is positioned radially outward from the power tool gearbox with respect to the drive axis when the detent system is coupled with the power tool.

16. A portable power tool system comprising:
a power tool, the power tool including
a drive mechanism for powering a tool output about a drive axis,
a power tool gear assembly coupled with the drive mechanism, and
a housing for supporting and retaining the drive mechanism and the power tool gear assembly, the housing including a gearbox for enclosing the gear assembly; and
a detent system configured to couple with the power tool housing and with a torque multiplier system, the detent system including
a detent housing for supporting at least one of a detent plate defining one or more detent apertures or a ball and spring device configured to push the ball against respective detent apertures of the one or more detent apertures, the detent housing defining an aperture through which a portion of the housing of the power tool can pass to couple the tool output with the multiplier gear assembly, wherein the detent housing includes a retaining ring supported within the aperture defined by the detent housing, the retaining ring configured to couple with a groove formed in a front end of the power tool housing to prevent axial motion of the power tool with respect to the drive axis, and wherein the ball and spring device is positioned radially outward from the power tool housing with respect to the drive axis when the detent system is coupled with the power tool.

17. The portable power tool system of claim 16, wherein the detent system further includes a bearing within the aperture defined by the detent housing to support the front end of the power tool housing within the detent housing.

18. The portable power tool system of claim 16, wherein the detent housing includes a threaded exterior surface configured to interface with a complementarily-threaded interior surface of the torque multiplier system.

19. The portable power tool system of claim 16, wherein the ball and spring device is positioned radially outward from the power tool gearbox with respect to the drive axis when the detent system is coupled with the power tool.

20. The portable power tool system of claim 16, wherein the housing of the power tool defines a second aperture into which the ball and spring device is seated, and wherein the detent housing includes the detent plate positioned such that rotation of detent system about the drive axis moves the one or more detent apertures into and out of alignment with the ball and spring device.
